(19) United States
(12) Patent Application Publication
(10) Pub. No.: US 2004/0249704 A1
(43) Pub. Date: Dec. 9, 2004

(54) Method of advertisement

(76) Inventors: Svetlana Zeldina, Brooklyn, NY (US); Felix Zeldin, Brooklyn, NY (US)

Correspondence Address: DILWORTH & BARRESE, LLP, 333 EARLE OVINGTON BLVD., UNIONDALE, NY, 11553, US

(21) Appl. No.: 10/454,426

(22) Filed: Jun. 3, 2003

(51) Int. Cl. G06F 17/60

(52) U.S. Cl. 705/14

(57) ABSTRACT

A method of advertisement includes duplication of service information, offered by multiple local businesses, on a display mount, which is configured to be permanently displayed on a surface within the home environment, and a regular-size card configured to be carried in a wallet.

### BACKGROUND OF THE INVENTION

1. Field of the Invention

The present invention relates to a method of advertisement. In particular, the invention relates to a method for advertising and using area-based selected businesses to facilitate communication between the residents of the local area and the selected businesses.

2. Background of the Invention

Where would we be, as a society, if not for creative advertisement? Of course, we all know that advertisement is the engine of our industrial success. Cars and candies, mattresses and tourist agencies along with myriads of other merchandises and services are promoted to become an integral and greatly appreciated part of our life. The advertisement provides a challenge to the consumer. Some commentators believe that consumers relish the challenge and, upon successful completion of the puzzle, transfer their positive feelings to the brand. There is, however the counter-argument that consumers are accustomed to the simplicity in interpretation of more traditional approaches to advertising.

Among various advertising techniques, reduction of retail prices on an item is a common example and can take many forms. For example, reduced-price “sales” are extensively and repeatedly conducted by many mass merchandisers. Discount coupons are also extensively used in merchandising. A typical discount coupon allows a purchaser to obtain a given product at a reduced price, or provides some additional consideration. Rebates comprise yet another form of price discounting.

Another popular advertising technique involves a distribution of advertisement material via mail. Typically, a variety of promotional materials such as coupons representing services are enclosed in an envelope in a rather disorganized manner. It is not unusual to have the sealed envelopes discarded as a junk mail. Even if consumers make an effort to leaf through the enclosed advertisement material, a manner in which this material arranged is so disorganized and confusing that, typically, everything ends up in the garbage. Furthermore, even if the enclosed advertisement material representing business of interest for the particular consumer was selected, a manner in which the selected material can be stored is inconvenient and non-demonstrative.

Thus, any advertisement campaign may have the following characteristics:

Unobtrusive omnipresence; and

Consumer's convenience.

It is, therefore, desirable to provide a method for advertising various consumer services selected to accommodate the geographically-defined needs of the target consumer and a system for implementing this method.

### SUMMARY OF THE INVENTION

In accordance with the invention, advertising information regarding multiple businesses is provided on a relatively large mount and in addition, on a standard size membership discount card that can easily fit in a wallet. Having the mount conspicuously attached to a visible place at home offers information about numerous businesses conveniently located in the vicinity of the cardholder's residence. Thus, one would have information about a variety of businesses grouped in a convenient manner on a single-piece mount. On the other hand, the cardholder, being afar from home, can immediately obtain the same information by dialing the numbers of his/her favorite local businesses, including medical offices, restaurants, stores, dry cleaners, and etc, listed on the membership discount card.

Alternatively, a package may include a mount with business information listed thereon and individual membership discount cards containing somewhat detailed information about a particular business. This embodiment is particularly advantageous for businesses offering an assortment of services or products to choose from, such as a restaurant menu. As often happens, a patron/cardholder driving home can greatly appreciate the possibility of having a takeout food ready by the time the caller is approaching his/her home. Selection of the discount cards is the subject to the customer's preferences.

According to a further aspect of the invention, the businesses interested in expanding their presence in a desired and well defined zone(s), can receive all necessary information about this zone and make an educated decision as to whether such advertisement is warranted by a local socio-economic situation.

To accomplish it, the inventive method allows for creating a computerized communication system between the administrator and prospective customers/businesses providing the interested business with necessary information in real time.

In accordance with a further aspect of the invention on the cardholder side of the inventive system, the system allow for providing cardholders with additional incentives while using their cards. For example, the use of the discount card may afford the cardholder a discount on services advertised on the discount card.

### BRIEF DESCRIPTION OF THE FIGURES

The above and other features and advantages of the invention will become more readily apparent from the following description taken in conjunction with the accompanying drawings in which:

FIG. 1 illustrates the context of the inventive system including a mount;

FIG. 1A illustrates the context of the inventive system if FIG. 1 and including a membership discount card;

FIG. 2 is a flow chart of a method in accordance with the invention.

FIG. 3 is a flow chart representing the service provider/customer aspect of the inventive system.

FIG. 4 is a flow chart representing the cardholder aspect of the inventive system.

### SPECIFIC DESCRIPTION OF THE DRAWINGS

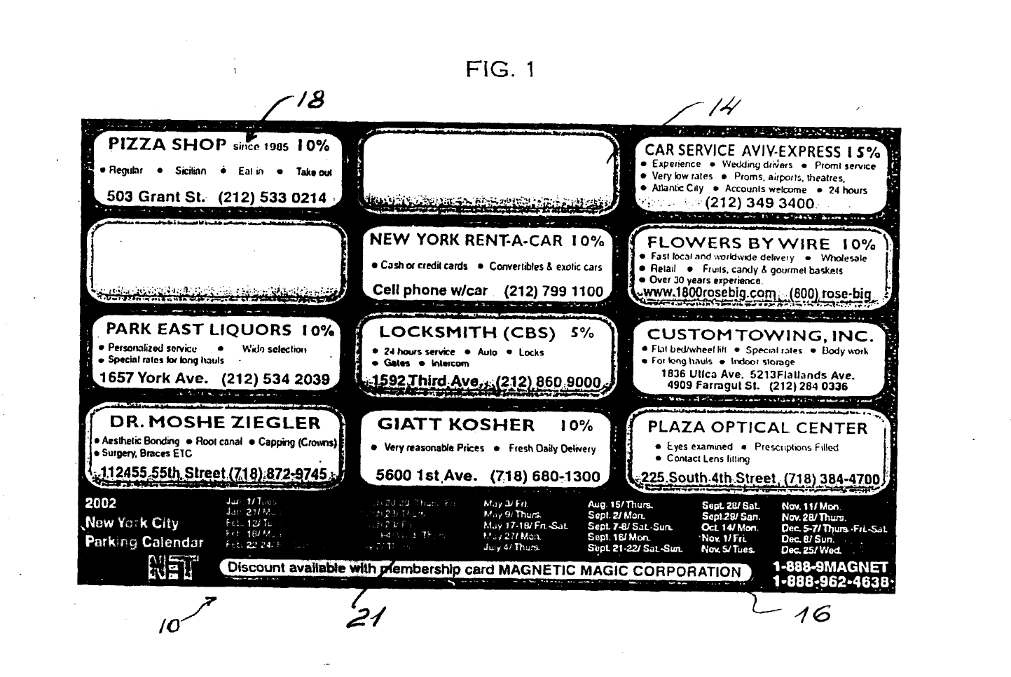

Referring to FIGS. 1 and 1A, an advertisement package includes a combination of mount 10 and a discount card 12. Mount 10 has a front face 14 and a rear face 16. The front face is designed to display a group of customers including businesses or service providers 18, wherein each advertised business is accompanied with a respective brief description of type of the business, address, e-mail address, and phone number. In addition, the mount 10 can provide information regarding additional incentives for customers, such as a discount for a desirable service when a cardholder uses the enclosed discount card, as described below.

The mount 10 is preferably a plate-shaped polygonal item, but other shapes such as an annular one are contemplated within the scope of the invention. Various means removably attaching the mount 10 to a support surface can be utilized within the scope of the invention; advantageously, however the mount 10 has a magnet means capable of attaching the mount to such visible home items as a refrigerator. Depending on the number of the advertised businesses, the mount 10 may have a fairly large size. To minimize the space occupied by the mount 10, the information may be divided between the mount's opposite faces 14 and 16. Alternatively, the mount may have an accordion-like folding structure including a multiplicity of vertically or horizontally extending segments and having only one of the flank segments attached to a support surface. Applying a force to the bottom of the mount or to one of its sides the user expands the latter in a manner sufficient to find a business of interest. Advantageously, materials used for manufacturing the mount 10 may fluoresce, and as result, not only the mount is more aesthetically appealing, but also it is practical since the information may be accessible in the dark. Not surprisingly, one would have an easy time calling, for example, an electrician, conveniently advertised on the mount, when the power went off.

Besides being a business-information carrier as well as an ornamental item, the mount may have means providing a homeowner with additional information of general nature. For example, as shown in FIG. 1, the bottom 21 of the mount 10 may have a city car-parking calendar, local sanitation schedule, holidays and etc. Also, such means as a thermometer, clock or just a mirror may be installed on the mount 10 as well.

The discount card 12 (FIG. 1A) is assigned a number 50 providing a cardholder with a membership ID allowing for a discount on services listed on the mount 10. To take advantage of this feature, the cardholder preferably activates the card 12 by calling or electronically contacting the administrator of the inventive system. The membership ID is stored in a central database accessible by participating businesses and is used every time a cardholder takes advantages of the advertised services. The discount membership card is enclosed with the mount 10 and can be either a separate part or coupled to the mount so that it can be easily detached upon opening an envelope. The discount membership card does not have to be of any specific size; however, it should be small enough to be carried in a wallet. Preferably, dimensions of the discount membership card 12 are comparable in size to a standard credit card. The front face of the discount membership card 12 has the same arrangement as the mount 10. However, depending on a size and number of service providers placed on the mount 10, it can be difficult or impractical to place all of the advertised businesses on a smaller-size card. Accordingly, the scope of the invention includes the inventive package containing as many discount cards as the number of the advertised businesses. One of the advantages of having a discount card individually assigned is to provide the cardholder with additional business information. Thus, for example, a discount card advertising a restaurant may have one of its opposite sides display a menu. Above all, the critical advantage of the inventive system is its accessibility. Whether one would like to take advantage of the advertised businesses listed on the mount or on the membership discount card, in most cases, the desired information may be readily available

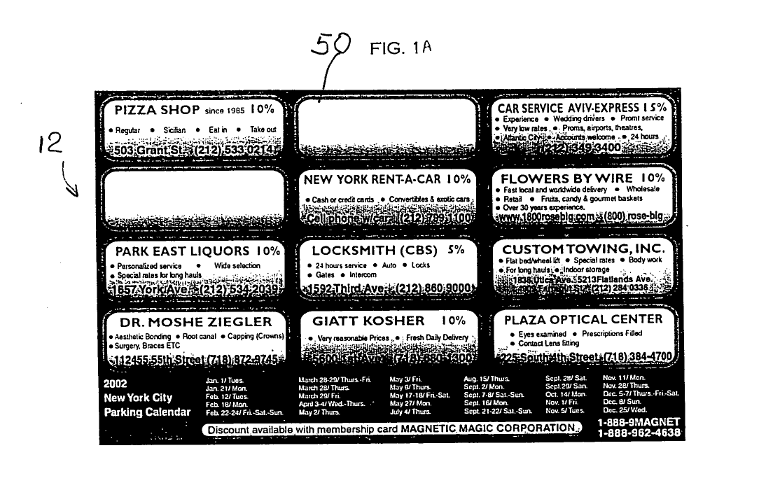

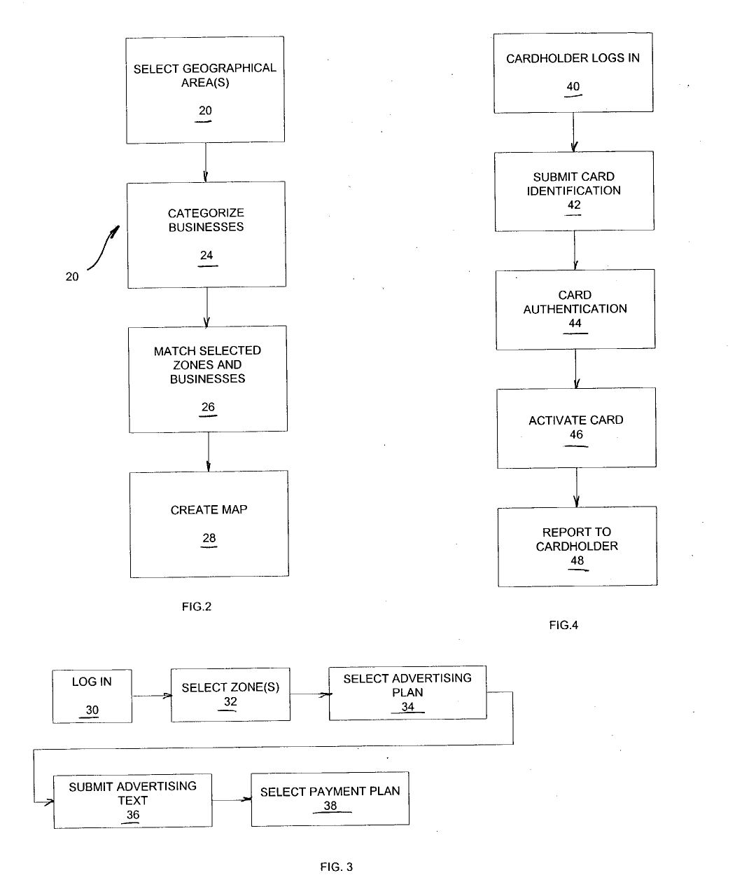

Turning to FIG. 2, an administrator 20 selects a given geographical area, which may, for example, include a few urban blocks, at 22. Once selected, all of the businesses located within this area are further categorized at 24 based on the nature of business, such as dry cleaners, restaurants, supermarkets and the like. Still, other criteria for categorizing the identified businesses may include even narrower identifiers such as ethnic cuisine, grocery stores and the like. As a result of such a selection, it is possible to group a few businesses of different or even like natures together and listed them at 26 on both the mount 10 and the membership discount card 12. Providing socio-economic information regarding a local zone(s) and intended to serve as a basis for a local advertisement campaign represents a unique possibility for developing one's business based on the local needs and demands. Finally, after having zones and businesses matched, the inventive method provides for the creation of a zone map 28 presented so that a viewer/business may immediately access the socio-economic structure of the selected zone. For example, the map may graphically indicate the concentration of the related businesses, offer a demographic data and even provide data related to the infrastructure of the selected zone.

Turning to FIG. 3, a customer may access the desired information after logging in at 30 and selecting desired zone(s) at 32. A respective map(s) providing the customer can provide the customer with all necessary information regarding a particular zone or zones. Based on this information, the customer may decide whether the socio-economic conditions are conducive to a successful advertising campaign in one or several zones. Further, the customer may select an advertisement plan at 34 based on how often the advertisement may be delivered to end users during a predetermined period of time. Finally after having submitted the information to be advertised at 36, the customer selects a payment plan offering an option of paying a lump sum or installments at 38. Additionally, in selecting the payment plan, the customer may choose between several plans all directed to offer a certain discount based on the frequency of advertisement, concentration of related business and the number of the desired zones. Such a system may not only be of interest for the existing businesses, seeking to expand their presence within a selected zone(s), but it may also attract those who only think of starting their own businesses.

FIG. 4 illustrates a card activation procedure. After an end user receives the inventive package and decides to subscribe to the services, the use may face an option of choosing a type of communication including computer, PALM or telephone communication. All necessary information necessary to contact the administrator at 40 is contained on the membership discount card. Upon submitting a card number at 42 to the administrator, its validity is verified by comparing the submitted number with the information contained in the database of the administrator at 44. If the identification is positive, the membership discount card is activated and its number is communicated to all participating businesses offering discounts on a variety of services and merchandises.

It is to be understood that while certain forms of the present invention have been illustrated and described herein, it is not to be limited to the specific forms or arrangement of parts described and shown.

What is claimed is:

1. A method of advertisement comprising the steps of:
selecting at least one geographical zone;
categorizing businesses located in the at least one geographical zone;
selectively providing information regarding the categorized businesses on a plurality of mount displays;
duplicating the information provided on the mount displays on a plurality of cards; and
delivering a plurality of packages each including at least one mount display and at least one card to residents of the at least one geographical zone.

2. The method of claim 1, wherein the categorization of businesses is provided based on a nature of business.

3. The method of claim 1, further comprising the steps of:
communicating with the categorized businesses within the selected geographical area; and
registering the categorized businesses desired to be advertised.

4. The method of claim 1, further comprising the steps of
creating a map of the at least one geographical area illustrating all of the categorized businesses; and
providing a socioeconomic information including a number and address of identical businesses, infrastructure of the at least one geographical area and sociological data to help the categorized businesses select an advertisement plan.

5. The method of claim 4, wherein the advertisement plan allows for optional frequency of sending the information to the residents of the at least one area and for a type and amount of payment for providing advertisement on the at least one display mount and card.

6. The method of claim 1, further comprising the steps of:
providing each card delivered to a respective resident with a unique number;
activating the card in response to positively identifying the number on the card upon a resident's request; and
offering the resident with the activated card a discount identified as part of the information on the image displays and the cards.

7. A method of advertisement comprising the steps of:
categorizing a variety of businesses located in a selected local geographical area;
providing information regarding the categorized businesses on a plurality of mount displays and on cards; and
delivering a plurality of packages each including at least one mount display and at least one card to residents of the selected geographical area.

8. The method of claim 7, wherein the at least one mount display and card have identical information.

9. The method of claim 7, wherein the at least one card includes a detail-oriented information about only one of the categorized businesses provided on the at least one display mount.

10. The method of claim 7, further comprising creating a map illustrating the categorized businesses and accessible to general public to help the categorized businesses select an advertisement plan.

11. An advertisement assembly comprising:
a display mount provided with information on a plurality of businesses located within a selected local area; and
a card having at least part of the information provided on the display mount.

12. The advertisement assembly of claim 11, wherein the card and the display mount have identical information.

13. The advertisement assembly of claim 11, wherein the display mount is operative to be removably attached to a surface so that the information is easily accessible.

14. The advertisement assembly of claim 13, wherein the fastener is a plate shaped body provided with a magnetic layer.

15. The advertisement assembly of claim 13, wherein the display mount has the information provided on one of or both opposite faces of the display mount.

16. The advertisement assembly of claim 13, wherein the display mount has an accordion-type structure provided with a plurality of foldable segments each having the information about a respective one of the categorized businesses.

17. The advertisement assembly of claim 13, wherein the mount display is made from fluorescent material.

18. The advertisement assembly of claim 11, wherein the card is smaller than the mount display and configured to be carried by a cardholder.

19. An advertisement system comprising:
a computer;
software executing on the computer and operative to categorize businesses located in a local area based on business nature;
software executing on the computer and operative to create a map of the local area provided with the categorized businesses; and
software executing on the computer and operative to provide access to the map by general public including the categorized businesses and residents of the local area;
software executing on the computer and operative to selectively register categorized businesses in response to a request filed by at least some of the registered business interested in advertising services.

20. The advertisement system of claim 19, further comprising software executing on the computer to provide each of the residents of the selected area with a respective number allowing a discount on the advertised services by the at least some of the categorized businesses.
